(19) United States
(12) Patent Application Publication
(10) Pub. No.: US 2025/0155652 A1
(43) Pub. Date: May 15, 2025

(54) HARDENED MULTICORE CONNECTOR AND FIBER OPTIC CONNECTOR

(71) Applicant: ANYCOM TECHNOLOGY CO., LTD., Shenzhen (CN)

(72) Inventors: Huapin Wang, Shenzhen (CN); Zhengwu Yang, Shenzhen (CN); Bingli Liu, Shenzhen (CN); Lin Wang, Shenzhen (CN)

(21) Appl. No.: 19/023,358

(22) Filed: Jan. 16, 2025

Related U.S. Application Data
(63) Continuation of application No. PCT/CN2024/102923, filed on Jul. 1, 2024.

(30) Foreign Application Priority Data
Sep. 28, 2023 (CN) 202322664372.1
Jan. 25, 2024 (CN) 202420199777.4

(51) Int. Cl. G02B 6/38

(52) U.S. Cl. CPC G02B 6/3885; G02B 6/3849; G02B 6/3874

(57) ABSTRACT

The present application discloses a hardened multicore connector and a fiber optic connector. The hardened multicore connector is configured to detachably connect to an external fiber optic connector and comprises a main body, a buffer member, a fiber optic assembly and a housing sequentially connected, wherein the main body is detachably connected to the housing to limit an axial movement among the main body, the fiber optic assembly, the buffer member and the housing; a limiting structure is provided in the housing and is configured to engage with the fiber optic assembly to limit a circumferential rotation of the fiber optic assembly; and the main body is provided with a first abutting portion, an outer sidewall of the fiber optic assembly is provided with a second abutting portion, and two end surfaces of the buffer member respectively abut against the first abutting portion and the second abutting portion.

### CROSS-REFERENCE TO RELATED APPLICATIONS

The present application is a continuation application of International Application No. PCT/CN2024/102923, filed on Jul. 1, 2024, which claims priority to Chinese Utility Model Application No. 202322664372.1, filed on Sep. 28, 2023 and Chinese Utility Model Application No. 202420199777.4, filed on Jan. 25, 2024, the entire contents of which are hereby incorporated by reference.

### TECHNICAL FIELD

The present application relates to the technical field of fiber-optic communication physical connection, and in particular, to a hardened multicore connector and a fiber optic connector.

### BACKGROUND

Optical fibers have been widely applied to scenarios such as broadband connections, which greatly improve the speed of voice, image and data transmission. When fiber optic connections are required, fiber optic cables are fastened to a ferrule in a fiber optic connector, and then a ferrule in a fiber optic connector at a female end is butted and fixed with a ferrule in a fiber optic connector at the other end, so that normal communication of the optical fibers can be achieved.

Fiber optic connections have very high requirements for connection precision. Once the ferrule is worn or damaged, the precision of the fiber optic connection will be greatly affected. When the female end is aligned with and connected to an external fiber optic connector, the ferrules of the female end and the external fiber optic connector inevitably collide with each other when in direct contact, and since the fiber optic connection stroke of the fiber optic connector at the female end is usually fixed, there is a high possibility that certain damage may be caused to the ferrules of the female end and the external fiber optic connector. In addition, since manufacturers or production batches of external fiber optic connectors are different, the external fiber optic connectors have different lengths of the connection strokes; consequently, after an external fiber optic connection device is connected to a female connector, the precision of fiber optic connection cannot be ensured, and it is possible that an end surface of the ferrule is damaged due to too large interference, or the ferrule end face cannot be contacted due to failure to achieve an interference state, resulting in the loss of optical signals.

At present, hardened multicore fiber optic connectors are usually assembled in a factory and are directly plugged with external fiber optic connection devices on site by an installer. As shown in FIG. 1a and FIG. 1b, when fiber optic connection is required, the hardened multicore fiber optic connector in the fiber optic connection assembly is connected to the external fiber optic connection device based on a certain polarity sequence, and normal communication of optical fibers can be achieved.

However, most hardened multicore fiber optic connectors are pre-assembled structures at present, and the polarities of external fiber optic connection devices may be different in different scenarios, so that a factory often needs to customize hardened multicore fiber optic connectors capable of adapting to the polarities of external fiber optic connection devices based on a requirement, which requires that the hardened multicore fiber optic connector with different polarities are prepared for standby. In addition, once the polarity of the external fiber optic connection device cannot adapt to that of the produced hardened multicore fiber optic connector at the mounting site, the hardened multicore fiber optic connector needs to be re-produced, which results in high rework costs and prolonged fiber optic connection cycles.

Therefore, how to avoid the loss of optical signals caused by the connection failure of the fiber optic assembly in the fiber optic connector during connection, thereby improving the precision of fiber optic connection, has become an urgent technical problem to be solved.

In addition, how to improve the adaptability of hardened multicore fiber optic connectors and enable the hardened multicore fiber optic connectors to adapt to external fiber optic connection devices with different polarities, thereby improving the convenience of production and use of hardened multicore fiber optic connectors has become an urgent problem to be solved.

### SUMMARY

The present application provides a hardened multicore connector and a fiber optic connector, which can avoid the loss of optical signals caused by the connection failure of the fiber optic assembly in the fiber optic connector during connection, thereby improving the precision of fiber optic connection.

According to a first aspect, the present application provides a hardened multicore connector configured to detachably connect to an external fiber optic connector. The hardened multicore connector comprises a main body, a buffer member, a fiber optic assembly and a housing sequentially connected, wherein: the main body is detachably connected to the housing, and the fiber optic assembly and the buffer member are sleeved therein, so that the fiber optic assembly and the buffer member are fixed between the main body and the housing to limit an axial movement among the main body, the fiber optic assembly, the buffer member and the housing; a limiting structure is provided in the housing, and the limiting structure is configured to engage with the fiber optic assembly to limit a circumferential rotation of the fiber optic assembly; the main body is provided with a first abutting portion, an outer sidewall of the fiber optic assembly is provided with a second abutting portion, the buffer member is fixed between the main body and the fiber optic assembly, and two end surfaces of the buffer member respectively abut against the first abutting portion and the second abutting portion, so that when the hardened multicore connector is aligned with and connected to the external fiber optic connector, the external fiber optic connector pushes the fiber optic assembly to axially move to enable the buffer member to deform, and therefore the hardened multicore connector is flexibly connected to the external fiber optic connector.

According to a second aspect, the present application provides a fiber optic connector, configured to detachably connect to the hardened multicore connector. The fiber optic connector comprises a main body, a plug-in member, a connecting member and a fiber optic head, a cavity is provided in the main body, the plug-in member and the connecting member are both hollow structures, and the fiber optic head is at least partially positioned within the hollow structures of the connecting member and the plug-in member, wherein a peripheral side of the connecting member is provided with at least two clamping structures; the plug-in member is provided with a guide structure, and the guide structure is configured to limit a connection direction of an hardened multicore fiber optic connector and an external fiber optic connection device to adapt to a fiber optic polarity; the plug-in member is detachably connected to the main body to change an orientation of the guide structure, when the guide structure is positioned at a first position relative to the main body, the hardened multicore fiber optic connector is adapted to a first fiber optic polarity, and when the guide structure is positioned at a second position relative to the main body, the hardened multicore fiber optic connector is adapted to a second fiber optic polarity; the plug-in member further comprises an engagement structure, and the engagement structure is engaged with the clamping structure to detachably connect the plug-in member and the connecting member to limit a circumferential rotation of the plug-in member and the connecting member; and the main body is provided with a connecting portion, and the engagement structure is engaged with the connecting portion to detachably connect the plug-in member and the main body, and fixes the connecting member through the plug-in member and the main body to limit the plug-in member, the connecting member and the main body.

The present application discloses a hardened multicore connector and a fiber optic connector. The hardened multicore connector comprises a main body, a buffer member, a fiber optic assembly and a housing sequentially connected, wherein the main body is detachably connected to the housing, and the fiber optic assembly and the buffer member are fixed between the main body and the housing, so that the main body, the fiber optic assembly, the buffer member and the housing are limited to move in the axial direction; meanwhile, the housing is provided with a limiting structure, and the limiting structure is engaged with the fiber optic assembly to limit the circumferential rotation of the fiber optic assembly in the hardened multicore connector, which ensures the stability of the internal structure of the hardened multicore connector and the precision of fiber optic connection; in addition, two ends of the buffer member respectively abut against a first abutting portion of the main body and a second abutting portion of the fiber optic assembly, so that when the hardened multicore connector is aligned with and connected to the external fiber optic connector, the fiber optic assembly can push the buffer member to deform to a certain extent after being subjected to external pushing force; therefore, the hardened multicore connector and the external fiber optic connector can be flexibly connected to avoid damage to the fiber optic assembly due to collision during the butting process, thereby improving the precision of the fiber optic butting between the hardened multicore connector and the external fiber optic connector.

### BRIEF DESCRIPTION OF THE DRAWINGS

To describe technical solutions in embodiments of the present application more clearly, the following briefly describes the accompanying drawings required for describing embodiments. Apparently, the accompanying drawings in the following descriptions show merely some embodiments of the present application, and those of ordinary skill in the art may still derive other accompanying drawings from these accompanying drawings without creative efforts.

FIG. 1 is a schematic diagram of an exploded structure of a hardened multicore connector according to an embodiment of the present application;

FIG. 2 is a schematic diagram of a structure of a main body in a hardened multicore connector according to an embodiment of the present application;

FIG. 3 is a schematic diagram of a structure of a housing in a hardened multicore connector according to an embodiment of the present application;

FIG. 4 is a schematic diagram of a cross-sectional structure of a hardened multicore connector according to an embodiment of the present application;

FIG. 5 is a schematic view of a structure of a fiber optic assembly in a hardened multicore connector according to an embodiment of the present application;

FIG. 6 is a schematic diagram of a structure of a fiber optic connector connected to a hardened multicore connector according to an embodiment of the present application;

FIG. 7 is a schematic diagram of a connecting portion between a hardened multicore connector and a fiber optic connector according to an embodiment of the present application;

FIG. 8 is a schematic diagram of a first connection manner among a main body, a buffer member and a fiber optic assembly according to an embodiment of the present application;

FIG. 9 is a schematic diagram of another structure of a main body in a hardened multicore connector according to an embodiment of the present application;

FIG. 10 is a schematic diagram of a support member in a hardened multicore connector according to an embodiment of the present application;

FIG. 11 is a schematic diagram of a boot in a hardened multicore connector according to an embodiment of the present application;

FIG. 12a is a schematic diagram of a connection with a fiber optic polarity A according to an embodiment of the present application;

FIG. 12b is a schematic diagram of a connection with a fiber optic polarity B according to an embodiment of the present application;

FIG. 13 is a schematic diagram of a structure of a connecting member in a fiber optic connector according to an embodiment of the present application;

FIG. 14 is a schematic diagram of a structure of a plug-in member in a fiber optic connector according to an embodiment of the present application;

FIG. 15a is a schematic diagram of a fiber optic connector according to an embodiment of the present application when adapting to a first fiber optic polarity;

FIG. 15b is a schematic diagram of a fiber optic connector according to an embodiment of the present application when adapting to a second fiber optic polarity;

FIG. 16 is a schematic diagram of a structure of a main body in a fiber optic connector according to an embodiment of the present application;

FIG. 17 is a schematic diagram of a connection between a main body and a connecting member in a fiber optic connector according to an embodiment of the present application; and

FIG. 18 is a schematic diagram of a structure of a main body in a fiber optic connector according to an embodiment of the present application viewed from another direction.

### DESCRIPTION OF THE EMBODIMENTS

The hardened multicore connector provided by the present application can be engaged with the fiber optic connector provided by the present application, and after the hardened multicore fiber optic connector is fastened to an external fiber optic connection device, the normal communication of optical fibers is achieved. The structures of the hardened multicore connector and the fiber optic connector are exemplarily described below with reference to the accompanying drawings of the specification.

### Embodiment 1

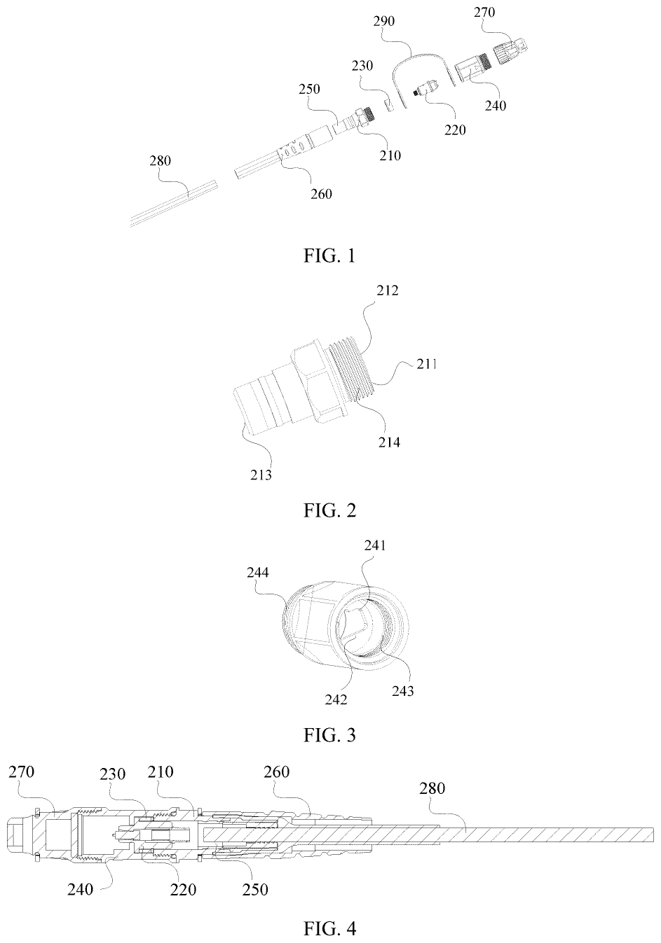

Referring to FIG. 1, FIG. 1 is a schematic diagram of an exploded structure of a hardened multicore connector according to an embodiment of the present application. As shown in FIG. 1, the hardened multicore connector comprises a main body 210, a buffer member 230, a fiber optic assembly 220 and a housing 240 sequentially connected.

In a specific implementation, the main body 210, the buffer member 230, the fiber optic assembly 220 and the housing 240 are all hollow structures to facilitate a fiber optic cable 280 to pass through. The fiber optic cable 280 passes through the buffer member 230 and the fiber optic assembly 220 sequentially from the main body 210, and is fastened to the fiber optic assembly 220. A ferrule 260 may be provided in the fiber optic assembly 220, and after passing through the fiber optic assembly 220, the fiber optic cable 280 is fastened to the ferrule 260 in the fiber optic assembly 220, so as to perform fiber optic butting with an external fiber optic connector. It may be understood that the ferrule 260 may be a part of the fiber optic assembly 220 or may be other structure independent of the fiber optic assembly 220.

The main body 210 is detachably connected to the housing 240, and the fiber optic assembly 220 and the buffer member 230 are sleeved therein, so that the fiber optic assembly 220 and the buffer member 230 are fixed between the main body 210 and the housing 240 to limit an axial movement among the main body 210, the fiber optic assembly 220, the buffer member 230 and the housing 240.

Referring to FIG. 2, FIG. 2 is a schematic diagram of a structure of a main body in an hardened multicore connector according to an embodiment of the present application. As shown in FIG. 2, the main body 210 comprises a first end 212 and a second end 213, a first connecting portion 214 is provided on an outer sidewall of the main body 210 close to the first end 212, and the first connecting portion 214 is configured to engage with the housing 240 to fasten or disconnect the main body 210 and the housing 240.

Referring to FIG. 3, FIG. 3 is a schematic diagram of a structure of a housing in a hardened multicore connector according to an embodiment of the present application. As shown in FIG. 3, one end of the housing 240 close to the main body 210 is provided with a second connecting portion 243, and the second connecting portion 243 is configured to engage with the first connecting portion 214 on the main body 210 to fasten or disconnect the main body 210 and the housing 240.

In a specific implementation, the main body 210 and the housing 240 may be detachably connected by a threaded connection or a snap-fitting connection. When the main body 210 and the housing 240 are detachably connected by a threaded connection, if the first connecting portion 214 is an external thread, the second connecting portion 243 is an internal thread; and if the first connecting portion 214 is an internal thread, the second connecting portion 243 is an external thread.

Referring to FIG. 4, FIG. 4 is a schematic diagram of a cross-sectional structure of an hardened multicore connector according to an embodiment of the present application. As shown in FIG. 4, when the main body 210 is fastened to the housing 240, the fiber optic assembly 220 and the buffer member 230 are sleeved in the main body 210 and the housing 240. In this case, one end of the buffer member 230 abuts against the main body 210, the other end of the buffer member 230 abuts against the fiber optic assembly 220, and meanwhile, one end of the fiber optic assembly 220 far away from the buffer member 230 abuts against the housing 240, so that the internal axial movement of the fiber optic assembly 220 and the buffer member 230 is limited, and the stable connection among the main body 210, the fiber optic assembly 220, the buffer member 230 and the housing 240 is achieved, thereby limiting the axial movement among the main body 210, the fiber optic assembly 220, the buffer member 230 and the housing 240.

As shown in FIG. 3, a limiting structure 241 is provided in the housing 240, and the limiting structure 241 is configured to engage with the fiber optic assembly 220 to limit a circumferential rotation of the fiber optic assembly 220.

In a specific implementation, the limiting structure 241 may be a hole adapted to a shape of the fiber optic assembly 220. When the main body 210 is fastened to the housing 240, the fiber optic assembly 220 is at least partially positioned inside the housing 240 and is engaged with the limiting structure 241 to achieve circumferential limitation. That is to say, when the main body 210 is fastened to the housing 240, one end of the fiber optic assembly 220 far away from the buffer member 230 is inserted into the hole of the limiting structure 241, and the fiber optic assembly 220 is limited by matching the shapes, so as to prevent the fiber optic assembly 220 from rotating circumferentially within the housing 240, and further ensure that the fiber optic cable 280 fastened to the fiber optic assembly 220 is not damaged, thereby ensuring the precision of the fiber optic connection of the hardened multicore connector.

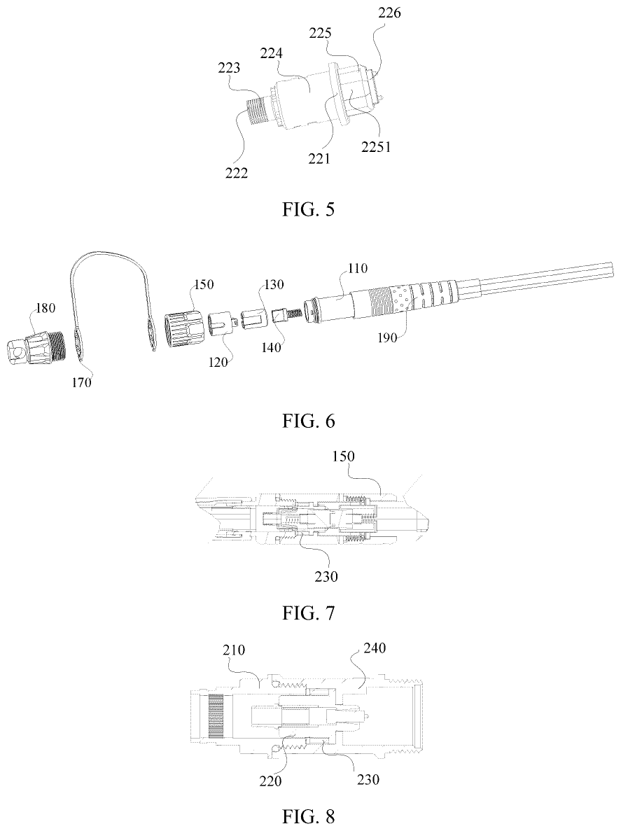

Referring to FIG. 5, FIG. 5 is a schematic view of a structure of a fiber optic assembly in an hardened multicore connector according to an embodiment of the present application.

As shown in FIG. 2 and FIG. 5, the main body 210 is provided with a first abutting portion 211, an outer sidewall of the fiber optic assembly 220 is provided with a second abutting portion 221, the buffer member 230 is fixed between the main body 210 and the fiber optic assembly 220, and two end surfaces of the buffer member 230 respectively abut against the first abutting portion 211 and the second abutting portion 221, so that when the hardened multicore connector is aligned with and connected to the external fiber optic connector, the external fiber optic connector pushes the fiber optic assembly 220 to move circumferentially to enable the buffer member 230 to deform, and therefore the hardened multicore connector is flexibly connected to the external fiber optic connector.

In a specific implementation, when the main body 210 is fastened to the housing 240, the fiber optic assembly 220 and the buffer member 230 are sleeved in the main body 210 and the housing 240; in this case, one end of the buffer member 230 abuts against the main body 210, and the other end of the buffer member 230 abuts against the fiber optic assembly 220. Specifically, one end surface of the buffer member 230 abuts against the first abutting portion 211, and the other end surface of the buffer member 230 abuts against the second abutting portion 221. The buffer member 230 can be a structure such as a silicone ring or a flexible gasket, which has a certain flexibility and can be deformed, preferably, the buffer member 230 can be a silicone ring with a certain width.

When the hardened multicore connector is aligned with and connected to an external fiber optic connector, the external fiber optic connector is inserted from one end of the housing 240 far away from the main body 210 in the direction of the main body 210, and a ferrule in the external fiber optic connector is butted with a ferrule 260 in the fiber optic assembly 220, so that the alignment and connection of the optical fibers are achieved. During the connection process, the external fiber optic connector can exert a pushing force on the fiber optic assembly 220 butted with the external fiber optic connector after being subjected to an external force, and the pushing force is in a direction from the housing 240 to the main body 210; in this case, one end surface of the buffer member 230 abuts against the first abutting portion 211, the other end surface of the buffer member 230 abuts against the second abutting portion 221, the fiber optic assembly 220 can transfer the pushing force to the buffer member 230, the buffer member 230 deforms under the force, and the deformation can offset the pushing force; therefore, the buffer effect is achieved in the alignment and connection process of the optical fibers, and the flexible butting between the hardened multicore connector and the external fiber optic connector is achieved.

Fiber optic connections have very high requirements for connection precision because low connection precision causes the loss of optical fiber signals. Compared with a rigid butting manner in the prior art, this flexible butting manner can better reduce the collision between two ferrules during the fiber optic butting process, thereby avoiding the ferrule damage caused by the collision and further improving the precision of the fiber optic butting between the hardened multicore connector and the external fiber optic connector.

In addition, when the fiber optic connectors at two ends are connected, the connection stroke is usually fixed. However, since the production quality and standards of different manufacturers are slightly different, the connection strokes of the external fiber optic connectors produced by different manufacturers may be slightly different. If the connection stroke of the external fiber optic connector is slightly large, a friction between the ferrules may increase or collision is even caused when the fiber optic connectors at the two ends are connected; consequently, the ferrules are damaged, connection precision is affected, and optical signals are lost to a certain extent.

However, according to the hardened multicore connector provided by the present application, the buffer member 230 can deform under the force, which allows a certain error in the connection stroke of the external fiber optic connector, and even if the connection stroke of the external fiber optic connector is slightly larger, which can be compensated by the deformation of the buffer member 230 after the force, so that the damage to the two ferrules can be avoided, thereby not only improving the applicability of the hardened multicore connector and enabling the hardened multicore connector to adapt to fiber optic connectors from different manufacturers, but also ensuring the precision of fiber optic connection on the basis of improving the applicability.

In addition, since the buffer member 230 can deform under the force, a repulsive force can be generated when the hardened multicore connector is butted with the external fiber optic connector, so that the connection between the hardened multicore connector and the external fiber optic connector is tighter.

Referring to FIG. 6 and FIG. 7, FIG. 6 is a schematic diagram of a structure of an external fiber optic connector connected to a hardened multicore connector according to an embodiment of the present application; and FIG. 7 is a schematic diagram of a connecting portion between an hardened multicore connector and an external fiber optic connector according to an embodiment of the present application.

As shown in FIG. 6, the external fiber optic connector comprises a body 110, a plug-in member 120, a connecting member 130, a fiber optic head 140 and a connecting nut 150. The body 110, the plug-in member 120, the connecting member 130 and the connecting nut 150 are all hollow structures, and the fiber optic cable is connected to the fiber optic head 140 after passing through the hollow structures of the body 110 and the connecting member 130. In a specific implementation, the fiber optic head 140 is at least partially positioned within the hollow structures of the connecting member 130 and the plug-in member 120 and is connected to a fiber optic plug of an external fiber optic connection device. In addition, a ferrule is provided in the fiber optic head 140, and the fiber optic cable is fastened to the ferrule in the fiber optic head 140.

The connecting nut 150 is sleeved outside the body 110 and is used for the fiber optic connector and external fiber optic connection device. In a specific implementation, the connecting nut 150 is sleeved on the body 110, an inner sidewall of the connecting nut 150 is provided with an internal thread, and after the hardened multicore fiber optic connector is aligned with and connected to an external fiber optic connection device, the connecting nut 150 is moved to enable the connecting nut 150 to be in threaded connection with an external thread on the external fiber optic connection device, so that the hardened multicore fiber optic connector can be tightly connected to the external fiber optic connection device, the connection firmness between the hardened multicore fiber optic connector and the external fiber optic connection device is improved, and the precision of fiber optic connection is ensured.

As shown in FIG. 3 and FIG. 7, the housing 240 is provided with a third connecting portion 244, and the third connecting portion 244 is configured to engage with an external fiber optic connector to achieve optical fiber butting. For example, the third connecting portion 244 is configured to engage with the connecting nut 150 to achieve a tight connection between the hardened multicore connector and the fiber optic connector as shown in FIG. 6.

When the hardened multicore connector is butted with the external fiber optic connector, the external fiber optic connector is inserted from one end of the housing 240 far away from the main body 210 to the direction of the main body 210, and the ferrule in the external fiber optic connector is butted with the ferrule 260 in the fiber optic assembly 220, so that the alignment and connection of optical fibers are achieved. During the connection process, the external fiber optic connector can apply a pushing force on the fiber optic assembly 220 butted with the external fiber optic connector under an external force, the pushing force is in a direction from the housing 240 to the main body 210, the fiber optic assembly 220 can transfer the pushing force to the buffer member 230, the buffer member 230 deforms under the force, and after the external force is removed, the buffer member 230 can generate a restoring force in a direction opposite to the direction of the pushing force, so that a repulsive force is applied to the third connecting portion 244, the friction force between the third connecting portion 244 and the connecting nut 150 is increased, and the connection between the hardened multicore connector and the external fiber optic connector is tighter.

In an embodiment, the first abutting portion 211 is an end surface of the first end 212 of the main body 210, the buffer member 230 is sleeved outside the fiber optic assembly 220 from a first end 22 of the fiber optic assembly 220, one end surface of the buffer member 230 abuts against the second abutting portion 221, and the other end surface of the buffer member 230 abuts against the end surface of the first end 212 of the main body 210.

As shown in FIG. 2 and FIG. 5, the buffer member 230 is sleeved outside the fiber optic assembly 220 from a direction of the first end 222 of the fiber optic assembly 220. The second abutting portion 221 is arranged on an outer peripheral side of the fiber optic assembly 220, and may be an annular flange structure specifically. It may be understood that the second abutting portion 221 may be a continuous structure provided circumferentially on the outer sidewall of the fiber optic assembly 220, or may be an intermittent structure as long as the second abutting portion can abut against the buffer member 230.

Referring to FIG. 8, FIG. 8 is a schematic diagram of a first connection manner among a main body, a buffer member and a fiber optic assembly according to an embodiment of the present application. As shown in FIG. 8, when the main body 210 is fastened to the housing 240, one end surface of the buffer member 230 abuts against the second abutting portion 221 of the fiber optic assembly 220, and the other end surface of the buffer member 230 abuts against the end surface of the first end 212 of the main body 210.

In another embodiment, the main body 210 is provided with a protruding portion 215, an outer diameter of the protruding portion 215 is less than an outer diameter of the first abutting portion 211, the buffer member 230 is sleeved on the protruding portion 215 from the first end of the main body 210, one end surface of the buffer member 230 abuts against the second abutting portion 221, and the other end surface of the buffer member 230 abuts against the first abutting portion 211.

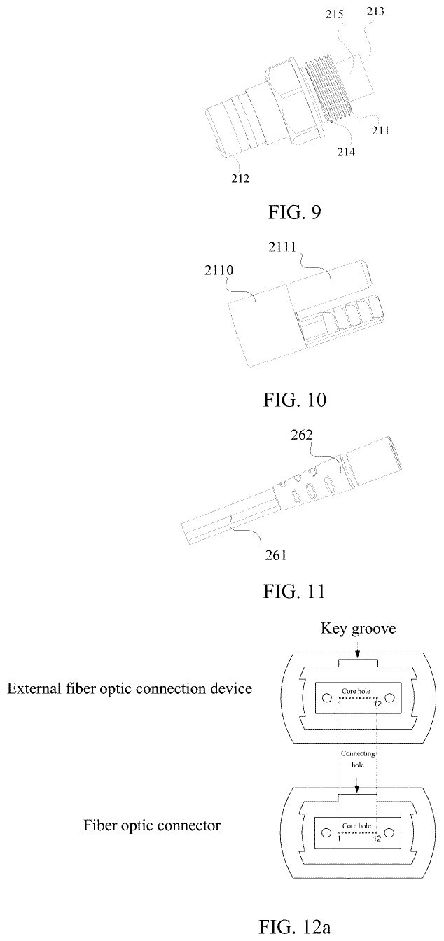

Referring to FIG. 9, FIG. 9 is a schematic diagram of another structure of a main body according to an embodiment of the present application. As shown in FIG. 5 and FIG. 9, the buffer member 230 is sleeved outside the fiber optic assembly 220 from a direction of the first end 22 of the fiber optic assembly 220. The second abutting portion 221 is arranged on an outer peripheral side of the fiber optic assembly 220, and may be an annular flange structure specifically. It may be understood that the second abutting portion 221 may be a continuous structure provided circumferentially on the outer sidewall of the fiber optic assembly 220, or may be an intermittent structure as long as the second abutting portion can abut against the buffer member 230.

The main body 210 is provided with a protruding portion 215. Specifically, the protruding portion 215 extends from a position of the first abutting portion 211 in a direction away from the first end of the main body 210 by a preset length, and the outer diameter of the protruding portion 215 is less than the outer diameter of the first abutting portion 211, so that a part of the main body 210 including the protruding portion 215 forms a stepped structure.

When the main body 210 is fastened to the housing 240, one end surface of the buffer member 230 abuts against the second abutting portion 221 of the fiber optic assembly 220, and the other end surface of the buffer member 230 abuts against the first abutting portion 211.

In an embodiment, the fiber optic assembly 220 comprises an assembly tail section 223, an assembly middle section 224 and an assembly head section 225 in sequence, the outer diameter of the buffer member 230 is less than or equal to the outer diameter of the first abutting portion 211, and the inner diameter of the buffer member 230 is greater than or equal to the outer diameter of the assembly middle section 224.

As shown in FIG. 5 and FIG. 8, when the main body 210, the fiber optic assembly 220 and the buffer member 230 are connected, the assembly tail section 223 is positioned inside the main body 210, and the buffer member 230 is sleeved outside the assembly middle section 224 of the fiber optic assembly 220, so that the outer diameter of the assembly tail section 223 is less than the inner diameter of the first end 212 of the main body 210, and the inner diameter of the buffer member 230 is greater than or equal to the outer diameter of the assembly middle section 224. Further, since the buffer member 230 needs to abut against the first abutting portion 211 of the main body 210, the outer diameter of the buffer member 230 needs to be less than or equal to the outer diameter of the first abutting portion 211. It may be understood that the equal referred to herein is not required to be exactly equal, but allows for a certain data error, as long as the outer diameter of the buffer member 230 is still greater than the inner diameter of the first abutting portion 211, and the buffer member 230 can abut against the first abutting portion 211.

In a specific implementation, the second abutting portion 221 can be positioned at a connection between the assembly middle section 224 and the assembly head section 225. Further, the assembly tail section 223 may be a structure independent of the assembly middle section 224 and assembly head section 225, for example, the assembly tail section 223 may be a separate component that snaps with the assembly middle section 224.

In an embodiment, a diameter of the assembly tail section 223 is less than a diameter of the assembly middle section 224 and a diameter of the assembly head section 225.

As shown in FIG. 5, the assembly tail section 223 has a diameter less than that of the assembly middle section 224, and the assembly tail section 223 is positioned inside the main body 210 when the main body 210 is fastened to the housing 240.

In an embodiment, the assembly head section 225 is provided with a key groove 2251.

As shown in FIG. 5, the assembly head section 225 is provided with a key groove 2251, and the key groove 2251 is configured to identify the connection polarity and connection direction of the hardened multicore connection.

In an embodiment, a connection platform 242 is provided in the housing 240, and the limiting structure 241 is arranged on the connection platform 242.

As shown in FIG. 3, the connection platform 242 is arranged inside the housing 240, and the connection platform 242 is also a hollow structure. Preferably, the hollow structure of the connection platform may be configured as a structure suitable for a size of the ferrule 260 of the fiber optic assembly 220 and may be used as the limiting structure 241.

In a specific implementation, since the buffer member 230 has a certain elasticity, after the fiber optic assembly 220 is forced to push the buffer member 230 to deform, the buffer member 230 can generate a restoring force. After the fiber optic assembly 220 is no longer subjected to external force, the restoring force generated by the buffer member 230 can push the fiber optic assembly 220 to move axially towards a direction far away from the main body 210, and in this case, the connection platform 242 can limit the axial movement of the fiber optic assembly 220 towards the direction far away from the main body 210, so as to prevent ferrule damage and optical fiber microbending caused by overlarge interference connection stress of the end surface of the ferrule when the hardened multicore connector is butted with the external fiber optic connector, and further ensure the precision of fiber optic connection.

In an embodiment, the hardened multicore connector further comprises a reinforcing member 250, the reinforcing member 250 is a hollow structure, and the reinforcing member 250 is fastened to the second end 213 of the main body 210.

As shown in FIG. 1, the reinforcing member 250 is a hollow structure, and the fiber optic cable 280 passes through the hollow structure of the reinforcing member 250. In a specific implementation, the reinforcing member 250 and the main body 210 may be non-detachably fastened. For example, the reinforcing member 250 may be integrally injection molded with the main body 210. Preferably, the reinforcing member 250 is a metal structure. The reinforcing member 250 can be compressed by press-fitting to deform the reinforcing member 250, thereby better clamping and fixing the fiber optic cable 280.

In an embodiment, referring to FIG. 10, FIG. 10 is a schematic diagram of a support member in a hardened multicore connector according to an embodiment of the present application. As shown in FIG. 10, the support member 2110 is arranged inside the reinforcing member 250, and the support member 2110 comprises at least two clamping arms 2111, and the at least two clamping arms 2111 are arranged oppositely. The opposite arrangement does not limit the symmetrical arrangement of the clamping arms 2111, as long as at least two clamping arms 2111 can clamp and fix the fiber optic cable 280. For example, three clamping arms 2111 may be provided, with an angle between the three gripper arms 2111 of 1200.

In a specific implementation, a fastening structure may be provided on the reinforcing member 250 and/or the clamping arms 2111. The fastening structure is a structure capable of increasing the friction between the reinforcing member 250 and/or the clamping arm 2111 and the fiber optic cable 280 when the reinforcing member 250 and/or the clamping arm 2111 is stressed, and may be, for example, an inverted tooth structure, and an angle of the inverted teeth is an acute angle.

In an embodiment, the hardened multicore connector further comprises a boot 260, wherein the boot 260 is fastened to the main body 210, and the reinforcing member 250 is sleeved therein.

Referring to FIG. 11, FIG. 11 is a schematic diagram of a boot in an hardened multicore connector according to an embodiment of the present application. As shown in FIG. 11, the boot 260 may comprise a heat shrink sleeve 261 and an outer sleeve 262, wherein the heat shrink sleeve 261 is sleeved on the first end 212 of the main body 210, the reinforcing member 250 is sleeved therein, and after the heat shrink sleeve 261 is heat-shrunk, the heat shrink sleeve 261 tightly covers the first end 212 of the main body 210 and the reinforcing member 250, thereby fixing the optical fiber cable 280. The outer sleeve 262 is sleeved outside the heat shrink sleeve 261 to protect the heat shrink sleeve 261 and prevent the fiber optic cable 280 from being bent.

In an embodiment, the hardened multicore connector further comprises a dust cap 270, and the dust cap 270 is detachably connected to the housing 240.

As shown in FIG. 1 and FIG. 3, the dust cap 270 is provided with a fourth connecting portion (not shown in the figure), the housing 240 is provided with a third connecting portion 244, and when the hardened multicore connector is not connected to an external fiber optic connector, the dust cap 270 is fastened to the third connecting portion 244 of the housing 240 through the fourth connecting portion, so that the sealing, dustproof and waterproof of the hardened multicore connector are achieved. In a specific implementation, the dust cap 270 and the housing 240 may be connected by a threaded connection or a buckling connection. Preferably, the fourth connecting portion is an internal thread, and the third connecting portion 244 is an external thread adapted to the fourth connecting portion.

In addition, a sealing member (not shown in the figure) is further provided in the dust cap 270, and a size of the sealing member may be the same as the inner diameter of a cover 7, so that the dustproof and waterproof effects are improved.

In an embodiment, as shown in FIG. 1, the hardened multicore connector further comprises a zipper 290, one end of the zipper 290 is connected to the dust cap 270, and the other end of the zipper 290 is connected to the main body 210. The dust cap 270 is connected to the main body 210 to prevent the dust cap 270 from being lost when the dust cap 270 is removed.

The hardened multicore connector provided by an embodiment of the present application comprises a main body, a buffer member, a fiber optic assembly and a housing sequentially connected, wherein the main body is detachably connected to the housing, and the fiber optic assembly and the buffer member are fixed between the main body and the housing, so that the main body, the fiber optic assembly, the buffer member and the housing are limited to move in the axial direction; meanwhile, the housing is provided with a limiting structure, and the limiting structure is engaged with the fiber optic assembly to limit the circumferential rotation of the fiber optic assembly in the hardened multicore connector, which ensures the stability of the internal structure of the hardened multicore connector and the precision of fiber optic connection; in addition, two ends of the buffer member respectively abut against a first abutting portion of the main body and a second abutting portion of the fiber optic assembly, so that when the hardened multicore connector is aligned with and connected to the external fiber optic connector, the fiber optic assembly can push the buffer member to deform to a certain extent after being subjected to external pushing force; therefore, the hardened multicore connector and the external fiber optic connector can be flexibly connected to avoid damage to the fiber optic assembly due to collision during the butting process, thereby improving the precision of the fiber optic butting between the hardened multicore connector and the external fiber optic connector.

### Embodiment 2

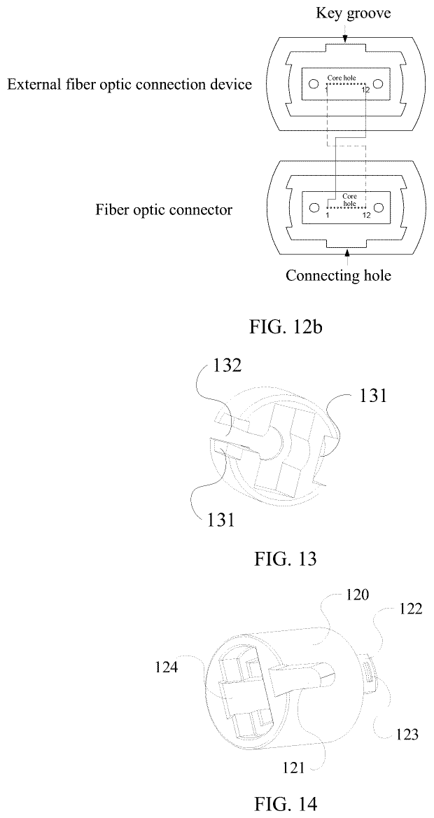

Taking a 12-core fiber optic cable as an example, as shown in FIG. 12a, when fiber optic connection is performed, based on the positions of the key groove of the external fiber optic connection device and the connecting hole on the hardened multicore fiber optic connector, a core 1 of the cable corresponding to the hardened multicore fiber optic connector is connected to a core 1 of the external fiber optic device correspondingly, a core 2 of the cable corresponding to the hardened multicore fiber optic connector is connected to a core 2 of the external fiber optic device correspondingly, a core 3 of the cable corresponding to the hardened multicore fiber optic connector is connected to a core 3 of the external fiber optic device correspondingly, and so on, and the fiber optic polarity is polarity A after connection is completed.

As shown in FIG. 12b, when fiber optic connection is performed, based on the positions of the key groove of the external fiber optic connection device and the connecting hole on the hardened multicore fiber optic connector, a core 1 of the cable corresponding to the hardened multicore fiber optic connector is connected to a core 12 of the external fiber optic device correspondingly, a core 2 of the cable corresponding to the hardened multicore fiber optic connector is connected to a core 11 of the external fiber optic device correspondingly, a core 3 of the cable corresponding to the hardened multicore fiber optic connector is connected to a core 10 of the external fiber optic device correspondingly, and so on, and the fiber optic polarity is polarity B after connection is completed.

It can be learned that the positions of the key groove on the external fiber optic connection device and the connecting hole on the hardened multicore fiber optic connector directly affect the connecting direction of the external fiber optic connection device and the hardened multicore fiber optic connector and the polarity of the connected optical fibers. During the actual mounting and application process, an orientation of the connecting hole on the hardened multicore fiber optic connector needs to be adjusted based on the requirements of different fiber optic polarities, so that the communication of the optical fibers can be completed correctly.

To improve the adaptability of the hardened multicore fiber optic connector and enable the hardened multicore fiber optic connector to adapt to external fiber optic connection devices with different polarities, thereby improving the convenience of production and use of hardened multicore fiber optic connectors, an embodiment of the present application provides an hardened multicore fiber optic connector and a fiber optic connection assembly including the hardened multicore fiber optic connector.

Referring to FIG. 6, FIG. 6 is a schematic diagram of an exploded structure of a hardened multicore fiber optic connector according to an embodiment of the present application. The hardened multicore fiber optic connector comprises a main body 110, a plug-in member 120, a connecting member 130 and a fiber optic head 140. The main body 110, the plug-in member 120 and the connecting member 130 are all hollow structures, and the fiber optic cable is connected to the fiber optic head 140 after passing through the hollow structures of the main body 110 and the connecting member 130. In a specific implementation, the main body 110, the plug-in member 120, the connecting member 130 and the fiber optic head 140 may be coaxially arranged.

The fiber optic head 140 is at least partially positioned within the hollow structures of the connecting member 130 and the plug-in member 120 and is connected to a fiber optic plug of an external fiber optic connection device. In a specific implementation, based on different interface environments of fiber optic connection, the fiber optic head 140 may be partially exposed or completely exposed outside the plug-in member 120, a head end of the fiber optic head 140 may also be flush with an end surface of the plug-in member 120 far away from the main body 110, and the head end of the fiber optic head 140 may also be positioned inside the plug-in member 120 and is not exposed outside.

As shown in FIG. 13, a peripheral side of the connecting member 130 is provided with at least two clamping structures 131. In a specific implementation, the clamping structure 131 may be a groove, a protrusion, a channel or other structures. It may be understood that, to facilitate the connection with the plug-in member 120 and ensure the connection precision, the clamping structure 131 may be configured such that one end of the clamping structure 131 is flush with one end surface of the connecting member 130 and axially extends from the end surface toward the main body 110 by a preset length.

As shown in FIG. 14, the plug-in member 120 is provided with a guide structure 121, and the guide structure 121 is configured to limit the connection direction of the hardened multicore fiber optic connector and the external fiber optic connection device to adapt to the polarity of the optical fiber. When the hardened multicore fiber optic connector is connected to an external fiber optic connection device, the guide structure 121 needs to be engaged with a guide structure arranged on the external fiber optic connection device to limit the connection direction of the hardened multicore fiber optic connector, so that the hardened multicore fiber optic connector can be connected based on a preset connection direction to adapt to the polarity of the optical fiber, and normal communication of the optical fibers is achieved. In a specific implementation process, the guide structure 121 may be a groove. It may be understood that the guide structure 121 may also be a protrusion. When the guide structure 121 is a protrusion, the guide structure on the external fiber optic connection device is a groove; and when the guide structure 121 is a groove, the guide structure on the external fiber optic connection device is a protrusion.

The plug-in member 120 is detachably connected to the main body 110 to change the orientation of the guide structure 121 and change the polarity of the optical fiber adapted to the hardened multicore fiber optic connector, when the guide structure 121 is positioned at a first position relative to the main body 110, the hardened multicore fiber optic connector is adapted to a first fiber optic polarity, and when the guide structure 121 is positioned at a second position relative to the main body 110, the hardened multicore fiber optic connector is adapted to a second fiber optic polarity.

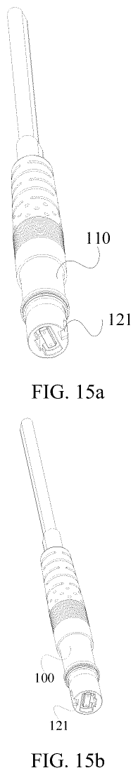

As shown in FIG. 15a, the orientation of the guide structure 121 is on a right side of the main body 110 (a direction relative to the paper), and when the hardened multicore fiber optic connector is connected to an external fiber optic connection device, the fiber optic polarity is the first fiber optic polarity. Since the plug-in member 120 is detachably connected to the main body 110, when it is necessary to adapt to external fiber optic devices with different polarities, the plug-in member 120 may be detached from the main body 110 and then rotated by 180°, and then the plug-in member 120 is connected to the main body 110, as shown in FIG. 15b, the orientation of the guide structure 121 is on a left side of the main body 110 (a direction relative to the paper), and when the hardened multicore fiber optic connector is connected to an external fiber optic connection device, the fiber optic polarity is the second fiber optic polarity. The change of the orientation of the guide structure 121 enables the same hardened multicore fiber optic connector to adapt to external fiber optic devices with different polarities, thereby achieving the conversion of the polarities of optical fibers and improving the adaptability of the hardened multicore fiber optic connector.

As shown in FIG. 14, the plug-in member 120 further comprises an engagement structure 122, and the engagement structure 122 is engaged with the clamping structure 131 to sleeve the plug-in member 120 outside the connecting member 130 and detachably connect to the connecting member 130. When the engagement structure 122 is engaged with the clamping structure 131, the plug-in member 120 is connected to the connecting member 130; in this case, a relative position between the plug-in member 120 and the connecting member 130 is fixed, and the circumferential rotation between the plug-in member 120 and the connecting member 130 is limited to a certain extent. In a specific implementation, the engagement structure 122 may be arranged on the plug-in member 120, or may axially extend from an end surface of the plug-in member 120 by a preset length.

In an embodiment, the engagement structure 122 and the clamping structure 131 may be connected in a buckling manner. In a specific implementation, for example, the engagement structure 122 may be a structure with a protrusion, and the clamping structure 131 may be a structure with a groove, so that the plug-in member 120 is connected to the connecting member 130 when the protrusion of the engagement structure 122 is aligned and engaged with the clamping structure 131. In this case, a relative position between the plug-in member 120 and the connecting member 130 is fixed, which not only limits the circumferential rotation between the plug-in member 120 and the connecting member 130, but also limits the axial movement between the plug-in member 120 and the connecting member 130.

In another embodiment, the engagement structure 122 and the clamping structure 131 may be connected in a plug-in manner. In a specific implementation, for example, the engagement structure 122 may be a connecting sheet extending from the plug-in member 120, and the clamping structure 131 may be a connecting channel, such that the plug-in member 120 is connected to the connecting member 130 when the connecting piece is inserted into the connecting channel of the clamping structure 131. In this case, the relative position between the plug-in member 120 and the connecting member 130 is fixed, and the circumferential rotation between the plug-in member 120 and the connecting member 130 is limited to a certain extent due to the engagement between the groove and the connecting member.

It may be understood that the above embodiments are only for illustrating the difference between the engagement structure 122 and the clamping structure 131 when limiting the relative movement between the plug-in member 120 and the connecting member 130, and do not limit the present application. The engagement structure 122 may also be a groove structure, and a structure of the clamping structure 131 engaged with the engagement structure 122 should be a protruding structure. In addition, the present application does not limit a specific position of the groove or the protrusion arranged on the engagement structure 122, and the groove or the protrusion may be arranged on an inner side of the engagement structure 122 or on an outer side of the engagement structure 122.

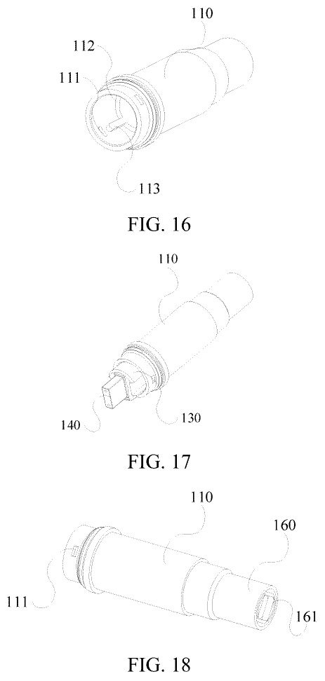

As shown in FIG. 16, the main body 110 is provided with a connecting portion 111, and the engagement structure 122 is engaged with the connecting portion 111 to detachably connect the plug-in member 120 and the main body 110, and fixes the connecting member 130 through the plug-in member 120 and the main body 110 to limit the plug-in member 120, the connecting member 130 and the main body 110. In a specific implementation, when the plug-in member 120 is detachably connected to the main body 110, the connecting element 130 may be at least partially positioned inside the plug-in member 120 and the main body 110, or may be at least partially positioned outside the plug-in member 120 and the main body 110, or may also be at least partially positioned outside the plug-in member 120 and inside the main body 110.

In a specific implementation, as shown in FIG. 16, an inner sidewall of the main body 110 is provided with a protruding platform 112, and when the plug-in member 120 and the connecting member 130 are mounted on the main body 110, one end of the connecting member 130 abuts against the protruding platform 112, so that the connecting member 130 is limited from moving axially toward a tail of the hardened multicore fiber optic connector. Similarly, a platform (not shown in the figure) may be provided inside the plug-in member 120, and when the plug-in member 120 is connected to the connecting member 130 through the engagement structure 122 and the clamping structure 131, the other end of the connecting member 130 abuts against the platform inside the plug-in member 120, so as to limit the connecting member 130 from moving axially toward a head of the hardened multicore fiber optic connector.

When the engagement structure 122 on the plug-in member 120 is engaged with the connecting portion 111, the plug-in member 120 is connected to the main body 110, and the connecting member 130 is positioned between the plug-in member 120 and the main body 110. In addition, due to the engagement between the engagement structure 122 and the connecting portion 111, the axial movement between the main body 110 and the plug-in member 120 is limited, and in this case, one end of the connecting member 130 abuts against the protruding platform 112 inside the main body 110, and the other end abuts against the platform inside the plug-in member 120, so that the position of the connecting member 130 is limited in the axial direction. The engagement between the engagement structure 122 and the clamping structure 131 also limits the circumferential rotation between the plug-in member 120 and the connecting member 130 to a certain extent.

When the hardened multicore fiber optic connector is connected to the external fiber optic connection device, the guide structure 121 on the plug-in member 120 is engaged with a guide structure on the external fiber optic connection device, so as to align and connect the external fiber optic connection device and the hardened multicore fiber optic connector.

In another embodiment of the present application, an inner sidewall of the engagement structure 122 may be provided with a protruding platform, when the engagement structure 122 is mounted on the main body 110, an end surface of the main body 110 abuts against the protruding platform on the inner sidewall of the engagement structure 122, and in this case, the main body 110 is at least partially positioned inside the plug-in member 120.

As shown in FIG. 17, the connecting member 130 is at least partially arranged within a cavity of the main body 110. In a specific implementation, a sidewall of the main body 110 may be provided with a protruding platform, one end of the connecting member 130 may abut against the protruding platform, and the other end of the connecting member 130 extends from the main body 110 and is positioned outside the main body 110. When the plug-in member 120 is detachably connected to the main body 110, the connecting member 130 is at least partially fixed inside the plug-in member 120 and the main body 110.

In an embodiment, as shown in FIG. 16, an inner sidewall of the main body 110 is further provided with a limiting portion 113. The limiting portion 113 is arranged along an axial direction of the main body 110. In a specific implementation, when the plug-in member 120 and the connecting member 130 are mounted on the main body 110, an opening slot 132 of the connecting member 130 is matched with the limiting portion 113, and in this case, the circumferential rotation of the connecting member 130 is limited by the limiting portion 113, and the circumferential rotation of the plug-in member 120 is further limited. It may be understood that, in this embodiment, the opening slot 132 is engaged with both the engagement structure 122 and the limiting portion 113.

When the engagement structure 122 on the plug-in member 120 is engaged with the connecting portion 111, the plug-in member 120 is connected to the main body 110, and the connecting member 130 is positioned inside the plug-in member 120 and the main body 110. In addition, due to the engagement between the engagement structure 122 and the connecting portion 111, the axial movement and circumferential rotation between the main body 110 and the plug-in member 120 are limited, and in this case, one end of the connecting member 130 positioned inside the plug-in member 120 and the main body 110 abuts against the protruding platform 112 inside the main body 110, and the other end abuts against the protruding platform inside the plug-in member 120, so that the position of the connecting member 130 is limited in the axial direction, and the limitation of the axial movement among the main body 110, the plug-in member 120 and the connecting member 130 is further achieved.

In this case, the circumferential rotation of the plug-in member 120 and the connection member 130 is limited, and the circumferential rotation of the plug-in member 120 and the main body 110 is limited, so that the circumferential rotation among the main body 110, the plug-in member 120 and the connection member 130 is limited.

The limiting portion 113 is arranged to better limit the circumferential direction of the connecting member 130, so that the stability and precision of the entire hardened multicore fiber optic connector including the main body 110, the plug-in member 120 and the connecting member 130 are improved.

In an embodiment, as shown in FIG. 13, an opening slot 132 is axially provided through one side of the connecting member 130, and the opening slot 132 is communicated with the hollow structure of the connecting member 130. During the manufacturing process of the hardened multicore fiber optic connector, the fiber optic head 140 connected to the fiber optic cable needs to be fixed to the connecting member 130, and the fiber optic cable often needs to pass through the hollow structure of the connecting member 130 first, and then the fiber optic cable passing through the connecting member 130 is assembled with the fiber optic head 140, which is inconvenient in assembly production. One side of the connecting member 130 is provided with the opening slot 132, the fiber optic cable and the fiber optic head 140 can be pre-assembled, and then the fiber optic cable of the fiber optic head 140 is mounted in the hollow structure of the connecting member 130 through the opening slot 132, so that the fiber optic head 140 and the connecting member 130 can be conveniently mounted and fixed.

In an embodiment, as shown in FIG. 13, at least two clamping structures 131 are provided, and two clamping structures 131 are symmetrically arranged on a peripheral side of the connecting member 130. The two clamping structures 131 are oppositely arranged on a peripheral side of the connecting member 130 at 180°, so that the plug-in member 120 can better fix the connecting member 130.

In an embodiment, two clamping structures 131 are provided, at least one of the clamping structures 131 is a groove having a preset length and axially arranged on an outer sidewall of the connecting member 130, the preset length is less than a length of the connecting member 130, and the groove is not communicated with the hollow structure of the connecting member 130. In a specific implementation, a groove with a preset length is provided on an outer sidewall of the connecting member 130, and the groove is the clamping structure 131. In addition, a length of the groove is less than that of the connecting member 130, that is, the clamping structure 131 arranged on the outer sidewall of the connecting member 130 does not axially penetrate through the connecting member 130. In addition, the clamping structure 131 is not communicated with the hollow structure of the connecting member 130.

It may be understood that the clamping structure 131 may be arranged at any position on the outer sidewall of the connecting member 130 in case of being engaged with the connecting portion 111.

For example, as shown in FIG. 13, one clamping structure 131 is arranged on each of two sides of the opening slot 132, and the other clamping structure 131 is arranged on one side of the connecting member 130 opposite to the opening slot 132. In a specific implementation, taking the clamping structure 131 as a groove as an example, the clamping structure 131 arranged on the opening slot 132 may be a groove having a preset width and arranged on each of two sides of the opening slot 132, and the other clamping structure 131 may be arranged on one side of the connecting member 130 symmetrical to the opening slot 132. In this case, the width of the clamping structure 131 arranged at one side of the opening slot 132 is a sum of the width of the opening slot 132 and the width of the grooves at two sides of the opening slot 132, and the width of the clamping structure 131 arranged at the corresponding side of the opening slot 132 should be equal to the width of the clamping structure 131 at the other side.

In an embodiment, as shown in FIG. 18, at least two connecting portions 111 are provided. In a specific implementation, when two or more connecting portions 111 are provided, at least two of the connecting portions 111 may be symmetrically arranged. As shown in FIG. 14, the plug-in member 120 is also provided with an engagement portion 123 engaged with the connecting portion 111, and the engagement portion 123 is engaged with the connecting portion 111 to limit axial movement between the plug-in member 120 and the main body 110. Through an engagement relationship between the connecting portion 111 and the engagement portion 123, the fastening between the plug-in member 120 and the main body 110 is achieved, and the plug-in member 120 is also detachable from the main body 110 through the engagement portion 123. In a specific implementation, the connecting portion 111 may be two through holes symmetrically arranged, and the engagement portion 123 is correspondingly configured as a protrusion. In other embodiments, the connecting portion 111 may also be other structures, such as a card structure extending from the main body 110, and the engagement portion 123 is a related structure engaged with the connecting portion 111, such as a through hole or a groove. It may be understood that the above specific structure is only for illustrating how the connecting portion 111 is connected to and engaged with the engagement portion 123, and other structures may be used to achieve the engagement between the connecting portion and the engagement portion.

In an embodiment, as shown in FIG. 16, the clamping structure 131 corresponds to a position of the connecting portion 111. The corresponding position means that the clamping structure 131 and the connecting portion 111 are positioned on the same side of the connecting member 130 and the main body 110, respectively, and can be engaged with each other. However, the specific structures, sizes and the like of the clamping structure 131 and the connecting portion 111 are not necessarily the same. As shown in FIG. 16, the engagement portion 123 is arranged on the engagement structure 122. Through the arrangement of the engagement portion 123 on the engagement structure 122, the main body 110, the plug-in member 120 and the connecting member 130 can be fastened to each other through one component (the engagement structure 122), so that the utilization rate of the structure is improved; and the engagement portion 123 is arranged on the engagement structure 122, so that the components in the hardened multicore fiber optic connector can be conveniently assembled.

In an embodiment, as shown in FIG. 14, the plug-in member 120 is further provided with a connecting hole 124, and the connecting hole 124 is communicated with the hollow structure of the plug-in member 120 for engaging with the key groove of the external fiber optic connection device. In a specific implementation, a specific shape of the connecting hole 124 may be designed based on a shape of the key groove of the external fiber optic connection device.

In addition, a profile of the end surface of the plug-in member 120 abutting against the external fiber optic connection device may also be designed based on a profile of an end surface of a connection surface of the external fiber optic connection device, so that the hardened multicore fiber optic connector can be better tightly connected to the external fiber optic connection device, and the precision of fiber optic connection is ensured.

In an embodiment, as shown in FIG. 6, the hardened multicore fiber optic connector further comprises a connecting nut 150, and the connecting nut 150 is sleeved outside the main body 110 for tightly connecting the hardened multicore fiber optic connector and the external fiber optic connection device. In a specific implementation, the connecting nut 150 is sleeved on the main body 110, an inner sidewall of the connecting nut 150 is provided with an internal thread, and after the hardened multicore fiber optic connector is aligned with and connected to an external fiber optic connection device, the connecting nut 150 is moved to enable the connecting nut 150 to be in threaded connection with an external thread on the external fiber optic connection device, so that the hardened multicore fiber optic connector can be tightly connected to the external fiber optic connection device, the connection firmness between the hardened multicore fiber optic connector and the external fiber optic connection device is improved, and the precision of fiber optic connection is ensured.

In an embodiment, as shown in FIG. 18, the hardened multicore fiber optic connector further comprises a press-fit member 160, the press-fit member 160 is arranged at one end of the main body 110 far away from the plug-in member 120, and the press-fit member 160 is at least partially positioned in the main body 110 and is integrally molded with the main body 110. In a specific implementation, the main body 110 is generally an injection molding member, and when the main body 110 is injection molded, the press-fit member 160 and the main body 110 are integrally molded, so that the firmness of the press-fit member 160 can be improved. In a specific implementation, the press-fit member 160 may be made of a metal material with low hardness, such as aluminum.

A clamping member 161 is further provided in the press-fit member 160. In a specific implementation, two clamping members 161 may be provided and are sheet structures, and the two clamping members 161 are symmetrically arranged; the clamping member 161 may also be a cylindrical structure; and the clamping member 161 may also be an integral body including a cylindrical main body and a card structure extending axially from the cylindrical main body.

When the fiber optic cable is press-fitted, the press-fit member 160 is compressed, meanwhile, the clamping member 161 is compressed by the press-fit member 160, so that the press-fit member 160 and the clamping member 161 deform, the fiber optic cable positioned in the clamping member 161 can be compressed after deformation, the press-fit member 160 and the clamping member 161 ensure that the fiber optic cable is clamped, and the fiber optic cable is fixed. In a specific implementation, the press-fit member 160 after press-fitting deforms, and a cross-section of the press-fit member may be circular or polygonal, which is not limited herein.

In an embodiment, the hardened multicore fiber optic connector further comprises a heat shrink sleeve, and the heat shrink sleeve is sleeved outside the press-fit member 160. The heat shrink sleeve is sleeved outside of the press-fit member 160, so that the press-fit member 160 and the fiber optic cable press-fitted by the press-fit member 160 can be better dustproof and waterproof.

In an embodiment, as shown in FIG. 14, the hardened multicore fiber optic connector further comprises a dust cap 180 and a zipper 170. One end of the dust cap 180 is provided with an external thread, when the hardened multicore fiber optic connector is not connected to an external fiber optic device, the dust cap 180 may be in threaded connection through the engagement of the external thread and the internal thread of the connecting nut 150, and therefore the dustproof effect is achieved on the hardened multicore fiber optic connector 1.

The zipper 170 may be provided on the dust cap 180, or may be provided on the main body 110. In an embodiment, one end of the zipper 170 is arranged on the dust cap 180, and the other end of the zipper 170 is arranged on the main body 110. In a specific implementation, the dust cap 180 may be provided with an annular groove, and one end of the zipper 170 may be sleeved in the annular groove in an annular manner, and of course, one end of the zipper 170 may also be directly or indirectly fixed on the dust cap 180 by other manners.

The present application discloses a hardened multicore connector and a fiber optic connector. The hardened multicore connector comprises a main body, a buffer member, a fiber optic assembly and a housing sequentially connected, wherein the main body is detachably connected to the housing, and the fiber optic assembly and the buffer member are fixed between the main body and the housing, so that the main body, the fiber optic assembly, the buffer member and the housing are limited to move in the axial direction; meanwhile, the housing is provided with a limiting structure, and the limiting structure is engaged with the fiber optic assembly to limit the circumferential rotation of the fiber optic assembly in the hardened multicore connector, which ensures the stability of the internal structure of the hardened multicore connector and the precision of fiber optic connection; in addition, two ends of the buffer member respectively abut against a first abutting portion of the main body and a second abutting portion of the fiber optic assembly, so that when the hardened multicore connector is aligned with and connected to the external fiber optic connector, the fiber optic assembly can push the buffer member to deform to a certain extent after being subjected to external pushing force; therefore, the hardened multicore connector and the external fiber optic connector can be flexibly connected to avoid damage to the fiber optic assembly due to collision during the butting process, thereby improving the precision of the fiber optic butting between the hardened multicore connector and the external fiber optic connector.

The foregoing descriptions are merely specific embodiments of the present application, but are not intended to limit the protection scope of the present application. Any modification or replacement readily figured out by a person skilled in the art within the technical scope disclosed in the present application shall fall within the protection scope of the present application. Therefore, the protection scope of the present application shall be subject to the protection scope of the claims.

What is claimed is:

1. A hardened multicore connector, configured to detachably connect to a fiber optic connector, wherein the hardened multicore connector comprises a main body, a buffer member, a fiber optic assembly and a housing sequentially connected, wherein:
the main body is detachably connected to the housing, and the fiber optic assembly and the buffer member are sleeved therein, so that the fiber optic assembly and the buffer member are fixed between the main body and the housing to limit an axial movement among the main body, the fiber optic assembly, the buffer member and the housing;
a limiting structure is provided in the housing, and the limiting structure is configured to engage with the fiber optic assembly to limit a circumferential rotation of the fiber optic assembly; and
the main body is provided with a first abutting portion, an outer sidewall of the fiber optic assembly is provided with a second abutting portion, the buffer member is fixed between the main body and the fiber optic assembly, and two end surfaces of the buffer member respectively abut against the first abutting portion and the second abutting portion, so that when the hardened multicore connector is aligned with and connected to the external fiber optic connector, the external fiber optic connector pushes the fiber optic assembly to axially move to enable the buffer member to deform, and therefore the hardened multicore connector is flexibly connected to the external fiber optic connector.

2. The hardened multicore connector according to claim 1, wherein the first abutting portion is an end surface of a first end of the main body; and
the buffer member is sleeved outside the fiber optic assembly from a first end of the fiber optic assembly, one end surface of the buffer member abuts against the second abutting portion, and the other end surface of the buffer member abuts against the end surface of the first end of the main body.

3. The hardened multicore connector according to claim 1, wherein the main body is provided with a protruding portion, and an outer diameter of the protruding portion is less than an outer diameter of the first abutting portion; and
the buffer member is sleeved on the protruding portion from the first end of the main body, one end surface of the buffer member abuts against the second abutting portion, and the other end surface of the buffer member abuts against the first abutting portion.

4. The hardened multicore connector according to claim 2, wherein the fiber optic assembly comprises an assembly tail section, an assembly middle section and an assembly head section in sequence; and
an outer diameter of the buffer member is less than or equal to the outer diameter of the first abutting portion, and an inner diameter of the buffer member is greater than or equal to an outer diameter of the assembly middle section.

5. The hardened multicore connector according to claim 4, wherein the assembly head section is provided with a key groove.

6. The hardened multicore connector according to claim 1, wherein a connection platform is provided in the housing, and the limiting structure is arranged on the connection platform.

7. The hardened multicore connector according to claim 1, further comprising:
a reinforcing member, wherein the reinforcing member is a hollow structure, and the reinforcing member is fastened to the main body.

8. The hardened multicore connector according to claim 7, further comprising:
a boot, wherein the boot is fastened to the main body, and the reinforcing member is sleeved therein.

9. The hardened multicore connector according to claim 1, further comprising:
a dust cap, wherein the dust cap is detachably connected to the housing.

10. A fiber optic connector, configured to detachably connect to the hardened multicore connector according to claim 1, wherein the fiber optic connector comprises a main body, a plug-in member, a connecting member and a fiber optic head, a cavity is provided in the main body, the plug-in member and the connecting member are both hollow structures, and the fiber optic head is at least partially positioned within the hollow structures of the connecting member and the plug-in member, wherein
a peripheral side of the connecting member is provided with at least two clamping structures;
the plug-in member is provided with a guide structure, and the guide structure is configured to limit a connection direction of an hardened multicore fiber optic connector and an external fiber optic connection device to adapt to a fiber optic polarity; the plug-in member is detachably connected to the main body to change an orientation of the guide structure, when the guide structure is positioned at a first position relative to the main body, the hardened multicore fiber optic connector is adapted to a first fiber optic polarity, and when the guide structure is positioned at a second position relative to the main body, the hardened multicore fiber optic connector is adapted to a second fiber optic polarity;
the plug-in member further comprises an engagement structure, and the engagement structure is engaged with the clamping structure to detachably connect the plug-in member and the connecting member; and
the main body is provided with a connecting portion, and the engagement structure is engaged with the connecting portion to detachably connect the plug-in member and the main body, and fixes the connecting member through the plug-in member and the main body to limit the plug-in member, the connecting member and the main body.

11. The hardened multicore fiber optic connector according to claim 10, wherein the connecting member is at least partially arranged in the cavity of the main body, and when the plug-in member is detachably connected to the main body, the connecting member is at least partially fixed inside the plug-in member and the main body.

12. The hardened multicore fiber optic connector according to claim 10, wherein an opening slot is axially provided through one side of the connecting member, and the opening slot is communicated with the hollow structure of the connecting member.

13. The hardened multicore fiber optic connector according to claim 12, wherein a limiting portion is further axially provided on an inner sidewall of the main body, and the limiting portion is engaged with the opening slot to limit a circumferential rotation between the main body and the connecting member.

14. The hardened multicore fiber optic connector according to claim 10, wherein at least two clamping structures are provided and arranged on the peripheral side of the connecting member.

15. The hardened multicore fiber optic connector according to claim 12, wherein two clamping structures are provided, at least one of the clamping structures is a groove having a preset length and axially arranged on an outer sidewall of the connecting member, the preset length is less than a length of the connecting member, and the groove is not communicated with the hollow structure of the connecting member.

16. The hardened multicore fiber optic connector according to claim 10, wherein at least two connecting portions are provided, the plug-in member is provided with an engagement portion adapted to the connecting portion, and the engagement portion is engaged with the connecting portion to limit an axial movement between the plug-in member and the main body.

17. The hardened multicore fiber optic connector according to claim 16, wherein the clamping structure corresponds to a position of the connecting portion, and the engagement portion is arranged on the engagement structure.

18. The hardened multicore fiber optic connector according to claim 10, wherein the plug-in member is further provided with a connecting hole, the connecting hole is communicated with the hollow structure of the plug-in member, and the connecting hole is configured to engage with the external fiber optic connection assembly.

19. The hardened multicore fiber optic connector according to claim 10, further comprising:
a connecting nut, wherein the connecting nut is sleeved outside the main body and is configured to fasten the hardened multicore fiber optic connector and the external fiber optic connection device.
